(19) United States
(12) Patent Application Publication
(10) Pub. No.: US 2011/0289506 A1
(43) Pub. Date: Nov. 24, 2011

(54) MANAGEMENT OF COMPUTING RESOURCES FOR APPLICATIONS

(75) Inventors: Jean-Michel Trivi, Boulder Creek, CA (US); David Sparks, Cupertino, CA (US)

(73) Assignee: Google Inc., Mountain View, CA (US)

(21) Appl. No.: 12/913,528

(22) Filed: Oct. 27, 2010

Related U.S. Application Data
(60) Provisional application No. 61/345,902, filed on May 18, 2010.

(51) Int. Cl. G06F 9/50

(52) U.S. Cl. 718/104

(57) ABSTRACT

The subject matter of this disclosure can be implemented in, among other things, a method. In these examples, the method includes receiving a resource request message to obtain access to a computing resource, and storing the resource request message in a data repository that stores a collection of resource request messages received from a group of applications executing on the computing device. The method may also include responsive to determining that the resource request message received from the first application has a highest priority of the collection of resource request messages, determining whether a second application currently has access to the computing resource, issuing a resource lost message to the second application to indicate that the second application has lost access to the computing resource, and issuing a resource request granted message to the first application, such that the first application obtains access to the computing resource.

This application claims the benefit of U.S. Provisional Application No. 61/345,902, filed May 18, 2010, the entire content of which is incorporated by reference herein.

### TECHNICAL FIELD

The disclosure relates to managing computing resources of a computing device, such as a personal computer, tablet computer, and cellular telephone.

### BACKGROUND

Modern computing devices may include one or more computing resources that may be utilized by an application executing on the computing device. In a computing device having multiple applications capable of utilizing a single resource of a computing device, such as an audio resource, conflicts may result when two or more of the applications attempt to simultaneously utilize the same resource. Conventionally, each application needs to be configured in light of the fact that some other application may attempt to simultaneously utilize the same resource by being configured to control the other application's resource usage in order to permit each application to operate as desired.

### SUMMARY

In general, this disclosure is directed to techniques for managing which application has priority to utilize a resource available to a computing device, such as an audio input or audio output element of the computing device or a transport control device coupled to the computing device. In one example, this disclosure describes an audio focus resource that is shared among applications that play or record audio and that enables each application to request and release the audio focus from an application management system without, in many instances, knowledge of any other applications in the system. In another example, this disclosure describes a transport control resource that is shared among applications that receive commands generated via a transport control device, such as a remote control.

In one example, an article of manufacture comprising a computer-readable storage medium encoded with instructions for causing one or more programmable processors of a computing device to receive, from a first application, a resource request message to obtain access to a computing resource of the computing device, and store the resource request message ing a data repository, wherein the data repository stores a collection of resource request messages received from a group of applications executing on the computing device. The computer-readable storage medium is further encoded with instructions that, responsive to determining the resource request message received from the first application has a highest priority of the collection of resource request messages, cause the programmable processors to determine whether a second application currently has access to the computing resource, and issue a resource request granted message to the first application indicating that the resource request message has been granted, such that the first application obtains access to the computing resource.

In another example, an article of manufacture comprising a computer-readable storage medium encoded with instructions for causing one or more programmable processors to issue a resource request message to a resource management module, wherein the resource request message requests access to a computing resource managed by the resource management module, and receive a resource request granted message from the resource management module indicating that the resource request message has been granted. The computer-readable storage medium is further encoded with instructions to, responsive to receiving the resource requested granted message, utilize the computing resource, receive a resource lost message from the resource management module indicating that access to the computing resource is lost, and, upon completing usage of the computing resource, issue a resource abandon message to the resource management module indicating a release of access to the computing resource.

In another example, a method includes receiving, from a first application with a resource management module executing on a computing device, a resource request message to obtain access to a computing resource, and storing the resource request message in a data repository with the resource management module, wherein the data repository stores a collection of resource request messages received from a group of applications executing on the one or more programmable processors. The method also includes responsive to determining that the resource request message received from the first application has a highest priority of the collection of resource request messages, determining whether a second application currently has access to the computing resource, and responsive to determining that the second application currently has access to the computing resource, issuing, with the resource management module, a resource lost message to the second application to indicate that the second application has lost access to the computing resource. The method also includes issuing, with the resource management module, a resource request granted message to the first application indicating that the resource request message has been granted, such that the first application obtains access to the computing resource.

In another example, a method includes issuing, with an application executing on a computer, a resource request message to a resource management module, wherein the resource request message requests access to a computing resource managed by the resource management module, and receiving, with the application, a resource request granted message from the resource management module indicating that the resource request message has been granted. The method also includes, in response to receiving the resource requested granted message, using the computing resource with the application, receiving a resource lost message from the resource management module indicating that access to the computing resource is lost, and upon completing usage of the computing resource, issuing, with the application, a resource abandon message to the resource management module indicating a release of access to the computing resource.

In another example, a system includes one or more processors, a first application executable by the one or more processors, a computing resource, a data repository, and a resource management module. The data repository is configured to store a sequence of resource request messages received from a group of applications executing on the one or more processors. The resource management module is executable by the one or more processors to receive, from the first application, a resource request message to obtain access to a computing resource from a first application, store the resource request message in the data repository, responsive to determining that the resource request message received from the first application has a highest priority of the collection of resource request messages, determine whether a second application currently has access to the computing resource, and, responsive to determining that the second application currently has access to the computing resource, issue a resource lost message to the second application to indicate that the second application has lost access to the computing resource. The system also includes means for issuing a resource request granted message to the first application indicating that the resource request message has been granted, such that the first application obtains access to the computing resource.

In another example a computer system includes one or more processors, a set of computing resources, means for managing the set of computing resources, and a software application. The software application is executable by the one or more processors to issue a resource request message to the resource management module, wherein the resource request message requests access to a computing resource managed by the means for managing the set of computing resources, receive a resource request granted message from the means for managing the set of computing resources indicating that the resource request message has been granted, utilize the computing resource in response to receiving the resource requested granted message, receive a resource lost message from the for managing the set of computing resources indicating that access to the computing resource is lost, and, upon completing usage of the computing resource, issue a resource abandon message to the means for managing the set of computing resources to indicate a release of access to the computing resource.

The techniques of this disclosure may provide several advantages. For example, these techniques may enable an application to utilize a computing resource of a computing device without having, in many cases, information about other applications executing on the computing device and without having, in various instances, information about any other applications that may already be using the desired computing resource. Furthermore, the techniques may enable an application to better control what happens when another application attempts to use a computing resource currently being used by the application. Thus, the techniques of this disclosure may provide better management of the usability issues that arise when an application attempts to use a computing resource of a computing device when another application is already using the computing resource. By better managing usability issues arising from computing resource conflicts, the user experience for an end user of the computing device may be improved.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example networked computing environment with applications running on a client device, in accordance with one aspect of the present disclosure.

FIG. 2 is a block diagram illustration an example client device, in accordance with one aspect of the present disclosure.

FIG. 3 is a conceptual diagram illustrating an example method for managing and using computing resources, in accordance with one aspect of the present disclosure.

FIG. 4 is a flowchart illustrating an example method for managing computing resources, in accordance with one aspect of the present disclosure.

FIG. 5 is a flowchart illustrating an example method for using computing resources, in accordance with one aspect of the present disclosure.

Like reference symbols in the various drawings indicate like elements.

### DETAILED DESCRIPTION

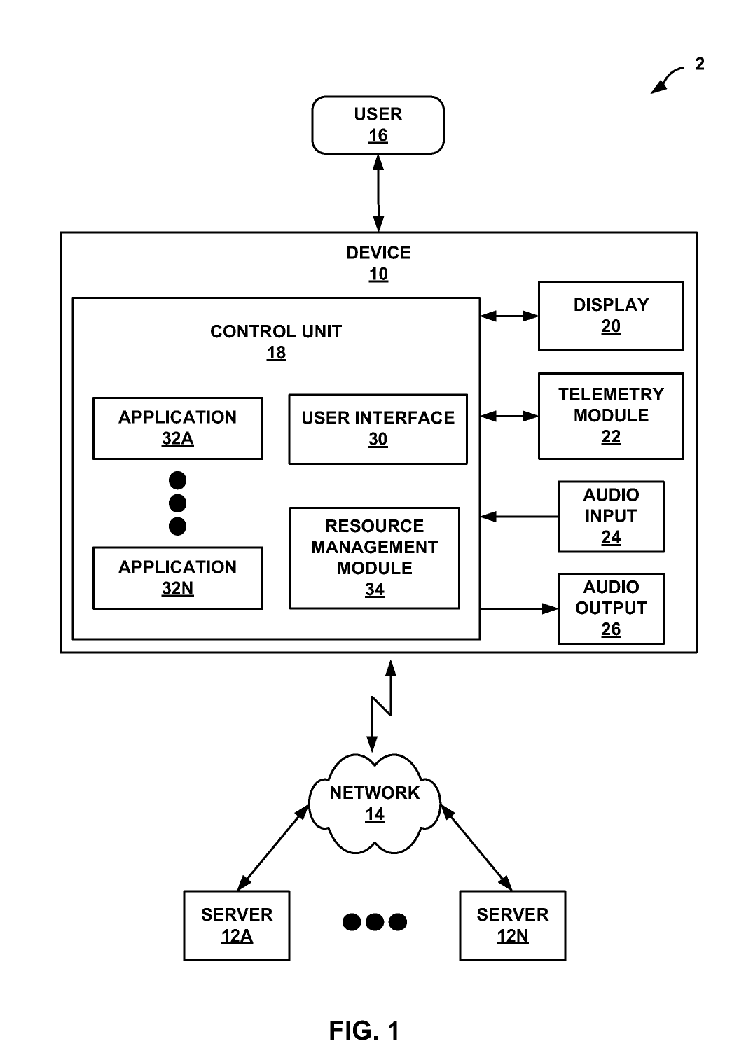

FIG. 1 is a block diagram illustrating an example networked computing environment 2 with applications running on a client device 10, in accordance with one aspect of the present disclosure. As shown in FIG. 1, computing system 2 includes device 10, one or more servers 12A-12N (“servers 12”), and network 14. Examples of device 10 include, but are not limited to, portable or mobile devices such as cellular phones, personal digital assistants (PDAs), laptop computers, portable gaming devices, portable media players, e-book readers, watches, as well as non-portable devices such as desktop computers. For purposes of illustration only in this disclosure, device 10 is described as a portable or mobile device that a user can carry, but aspects of this disclosure should not be considered limited to portable or mobile devices.

Device 10 and servers 12 are coupled to network 14 via wired and/or wireless links. Device 10 may send data to or receive data from servers 12 via network 14. Network 14 may include a wide-area network such as the Internet, a local-area network (LAN), an enterprise network, a wireless network, a cellular network, or one or more other types of networks. Servers 12 may be any of several different types of network devices. For instance, servers 12 may be conventional web servers, specialized media servers, personal computers operating in a peer-to-peer fashion, or other types of network devices.

Device 10 may include a control unit 18, a display 20, a telemetry module 22, an audio input 24, and an audio output 26. For example, where device 10 is a cellular phone, audio input 24 may include a microphone and audio output 26 may include a speaker for voice communication. Display 20 may be a liquid crystal display (LCD), e-ink, or other display. Display 20 presents the content of device 10 to user 16. For example, display 20 may present the applications executed on device 10 such as a web browser or a video game, content retrieved from servers 12, and other functions that may need to be presented to user 16. For example, display 20 may be a touch screen that allows user 16 to interact with device 10. In this example, the functionality of user interface 30 and display 20 may be merged. Although device 10 is shown as including display 20, aspects of this disclosure should not be considered limited to examples that include display 20. In some examples of device 10, display 20 may be optional. For example, if device 10 comprises a music player or a radio, device 10 may not include a display 20.

Control unit 18 may provide an operating environment for executing user interface 30, various applications 32A-32N (collectively, “applications 32”), and resource management module 34, as well as storing a collection of resource requests in one or more data structures (not shown in FIG. 1). Control unit 18 may include one or more microprocessors (not shown in FIG. 1) that execute software instructions, such as those used to define a software or computer program, stored on a tangible computer-readable storage medium (not shown in FIG. 1). Examples of computer-readable storage media include a storage device (e.g., a disk drive, or an optical drive), or memory (such as Flash memory, random access memory or RAM) or any other type of volatile or non-volatile memory, that stores instructions to cause a programmable processor to perform the techniques described herein. Alternatively, or in addition, the control unit may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of one or more of the foregoing examples of dedicated hardware, for performing the techniques described herein.

Control unit 18 provides an operating environment for executing one or more of applications 32 either alone or simultaneously. Examples of applications 32 include web browsers, e-mail, programs to retrieve stock quotes, programs to search for restaurants, programs that retrieve current and future weather information, games, programs that play audio and/or video files, programs to search the Internet, programs that provide news, programs that provide maps, and other programs. Applications 32 may be executed based on a request from user 16, and may be terminated based on a request from user 16. Some applications 32 may be running continuously in the background. Some applications 32 may be executed automatically by device 10 such as at power up and may be terminated automatically by device 10 such as at power down. Each of applications 32 may utilize various resources of device 10, including, for example, audio input 24 and/or audio output 26, during execution.

In some examples, any application executed within control unit 18 may require data from one or more of servers 12. Telemetry module 22 transmits a request for the data and receives the data from one or more of servers 12. Telemetry module 22 may provide the received data to control unit 18 for further processing. Telemetry module 22 is configured to transmit data/requests to and receive data/responses from one or more servers 12 via network 14. Telemetry module 22 may support wireless or wired communication, and includes appropriate hardware and software to provide wireless or wired communication. For example, telemetry module 22 may include an antenna, modulators, demodulators, amplifiers, and other circuitry to effectuate communication between device 10 and one or more of servers 12.

For example, control unit 18 may provide an operating environment for executing application instructions associated with the Google Maps application, e.g., application 32A. User 16 may interact with user interface 30 and/or display 20 to execute the application 32A. User 16 may then interact with user interface 30 and/or display 20 to select a geographic location into the displayed Google Maps application. In this example, telemetry module 22 may transmit a request to one or more of servers 12, via network 14, for the requested map information. Display 20 then presents the received map content to user 16.

In another example, user 16 interacts with user interface 30 and/or display 20 to select a geographic origin and a geographic destination within the Google Maps application and directs the Google Maps application to provide driving directions from the origin to the destination. In some examples, the Google Maps application may be configured to provide audio driving directions. To output the audio driving directions, the Google Maps application may utilize audio output 26. In accordance with the techniques of this disclosure, the Google Maps application may request, from resource management module 34, the right to utilize audio output 26 by, for example, requesting the use of an “audio focus” resource.

In general, resource management module 34 manages requests from applications 32 to use the resources available to device 10. Applications 32 may include any applications executing within device 10, including an operating system executing on device 10 or other applications executing on device 10 and executing within the operating environment provided by an operating system. Resource management module 30 may receive a request for one or more resources of device 10, e.g., audio input 24 and audio output 26, from one or more applications 32. In response to receiving the request, resource management module 34 may add the request to a request queue, stack, or other data structure configured to store resource requests. Based on the requests in the queue, resource management module 34 may grant the requesting application, e.g., application 32A, access to use the requested resource. Resource management module 34 may manage the ability for each requesting application to utilize requested resources of device 10 by managing various “resource focus” resources and maintaining one or more data structures for the resource requests for the resources available within device 10. In some examples, each resource available within device 10 is associated with a data structure for maintaining the resource requests. In other examples, the resource requests for two of the resources available within device 10 may be maintained within a single data structure.

Each resource of device 10 that may be utilized by one or more application may be configured with a unique resource focus resource that is managed by resource management module 34. For example, resource management module 34 may manage an audio focus resource to control which of applications 32 is permitted to receive audio input via audio input 24 or output audio via audio output 26. In another example, resource management module 34 may manage a “remote control focus” resource to control which of applications 32 receive inputs from user 16 entered via a remote control coupled to device 10.

Continuing the example from above, when the Google Maps application requests the right to utilize audio output 26, the Google Maps application may issue a request for an audio focus resource from resource management module 34. Resource management module 34 may add the request to the data structure configured to maintain the audio focus resource requests. In one example, because the audio focus request issued by the Google Maps application is the most recent audio focus request, resource management module 34 grants the Google Maps application control over audio input 24 and audio output 26. That is, when granting the audio focus resource to a requesting application, resource management module 34 causes any other application that may be using the audio resources of device 10 to stop or otherwise alter the other applications' use of the audio resources while providing access to the audio resources to the requesting application.

When the Google Maps application no longer requires use of audio input 24 or audio output 26, the Google Maps application may issue an audio focus abandon message to resource management module 34. In response to receiving the release message, resource management module 34 removes the Google Maps application audio focus request from the data structured used to store the audio focus requests. If one or more other applications, e.g., a different one of applications 32, previously requested the audio focus resource, resource management module 34 grants the requesting application having the highest priority usage of the audio focus resource.

When multiple applications request use of a resource focus resource, e.g., the audio focus resource, resource management module 34 may determine which requesting application is granted usage of the resource focus resource using a priority system, where the highest priority application is granted usage of the resource focus resource. In one example, the application priority may be determined by, for example, the how recently each application requested use of the resource focus resource. The highest priority application may be the application that most recently requested the resource focus resource. In another example, the priority may be determined based upon the type of resource focus request issued by the requested application. For example, an application requesting usage of a resource focus resource for a short duration, i.e., a transient resource focus request, may receive higher priority than an application requesting a resource focus resource for an unknown duration.

While described in the examples above as resource management module 34 receiving a direct request from one of applications 32, applications 32 may also implicitly request a resource focus resource by, for example, initiating audio output without sending a request for the audio focus resource to resource management module 34. Resource management module 34 may monitor resource usage and interpret an application initiating resource usage without sending a direct request as the application implicitly requesting usage of the resource. That is, if one of applications 32 begins utilizing a resource managed by resource management module 34 without directly requesting usage of the resource from resource management module 34, resource management module 34 interprets the usage of the resource as receiving a request from the application to use the resource. Upon detecting such an implicit request, resource management module 34 may manage usages of the requested resource in substantially the same manner as described above with respect to receiving direct resource requests.

In this manner, the resource management module 34 manages the usage of the various resources available within device 10 by applications 32 without requiring each of applications 32 to be configured with information about the other applications 32 executing on device 10. Rather, each of applications 32 may be configured to request a resource focus resource from resource management module 34 prior to using the requested resource and issue a resource focus release message to resource management module 34 when each application 32 no longer needs to use the resource.

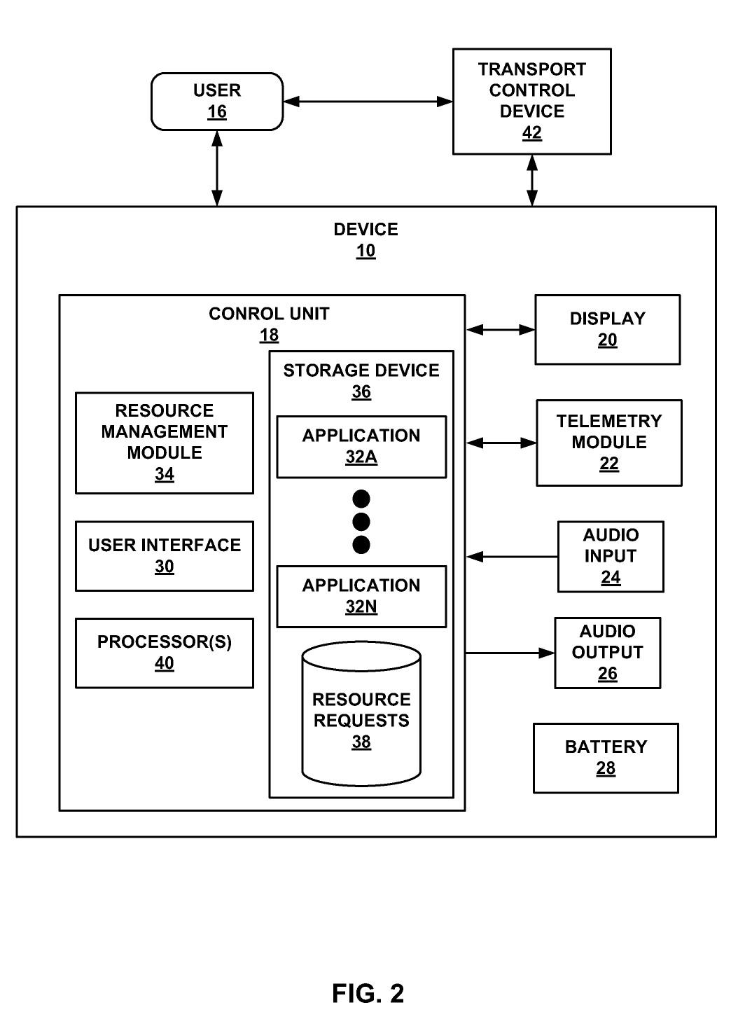

FIG. 2 is a block diagram illustration an example client device, in accordance with one aspect of the present disclosure. As shown in FIG. 2, device 10 may be coupled with transport control device 42 and may include battery 28. Transport control device 42 may include, for example, a remote control through which user 16 may control the execution of one or more applications 32. In one embodiment, transport control device 42 may be coupled to device 10 using a wired connection when included as an element in pair of headphones. In another embodiment, transport control device 42 may be wirelessly coupled to device 10 via a Bluetooth®, 802.1a/b/g/n, infrared, or other wireless connection capable of transmitting messages between device 10 and transport control device 42. In some examples, transport control device 42 may include a display (not shown). Battery 28 provides power for all the various units of device 10, and may be rechargeable. Examples of battery 28 include a lithium polymer battery, a lithium ion battery, nickel cadmium battery, and a nickel metal hydride battery.

As illustrated in FIG. 2, control unit 18 includes storage device 36 and processors 40. Control unit 18 stores instructions for applications 32 that may be executed by one or more processors 40 within storage device 36. For purposes of illustration only in the following description, the applications that may be executed by one or more processors 40 are described below as being executed by one processor 40. The applications may be downloaded by user 16 via network 14 (e.g., from one or more of servers 12) or may be preprogrammed within device 10. The applications may be executed by processor 40 in response to user 16 interacting with device 10 to execute the applications. The applications may also be executed by processor 40 when user 16 turns on device 10.

Storage device 36 may also include instructions that cause processor 40 to perform various functions ascribed to processor 40 in this disclosure. Storage device 36 may comprise a computer-readable, machine-readable, or processor-readable storage medium that comprises instructions that cause one or more processors, e.g., processor 40, to perform various functions. Storage device 36 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media. In some embodiments, storage device 36 may comprise one or more of a non-transitory/tangible storage media, where the data stored in such media may or may not change (e.g., ROM, RAM).

User 16 may interact with user interface 30 and/or display 20 to execute one or more of applications 32 stored on storage device 36. Some applications 32 may be executed automatically by device 10 such as when device 10 is turned on or booted up. In response, processor 40 executes the one or more applications selected by user 16, or executes the one or more applications executed by device 10. Processor 40 may include any one or more of a microprocessor, a controller, a digital signal processor (DSP), an application specific integrated circuit (ASIC), a field-programmable gate array (FPGA), or equivalent discrete or integrated logic circuitry. Additionally, the functions attributed to processor 40, in this disclosure, may be embodied as software, firmware, hardware or any combination thereof.

Processor 40 may execute one or more of applications 32 either alone or simultaneously. Examples of applications 32 include web browsers, e-mail, programs to retrieve stock quotes, programs to search for restaurants, programs that retrieve current and future weather information, games, a program to search the Internet, a program that provides news, a program that provides maps, a program that plays music, a program that records audio, a program that provides driving directions, and other programs executed by processor 40. Applications 32 may be executed based on a request from user 16, and may be terminated based on a request from user 16. Some applications 32 may be running continuously in the background. Some applications 32 may be executed automatically by device 10 such as at power up and may be terminated automatically by device 10 such as at power down.

As one example, storage device 36 may store application instructions associated with the Google Voice application, e.g., application 32A. User 16 may interact with user interface 30 and/or display 20 to execute the Google Voice application. Processor 40 then executes the Google Voice application and causes display 20 to display the application to user 16. User 16 may then interact with user interface 30 and/or display 20 to review voicemail messages, record voicemail greetings, or send a text message to another person. In one example, the voicemail information is stored on one or more of servers 12 of FIG. 1. In this example, telemetry module 22 transmits a request to one or more of servers 12, via network 14, for the requested website. Display 20 then presents the received content to user 16.

Each of applications 32 may be configured to request a resource focus resource from resource management module 34 prior to using a shared resource. In one embodiment, prior to playing or recording audio, each application may request the audio focus resource from resource management module 34. Resource management module 34 maintains a list of applications requesting each resource within resource requests 38. In some examples, the list of applications requesting the audio focus resource may be maintained within resource requests 38 as a first-in-last-out stack. Resource management module 34 may grant access to audio resources based upon which application request is on top of the stack, for example. That is, the application that most recently requested the audio focus resource is added to the top of the stack and resource management module 34 grants the requesting application access to utilize the audio resources, e.g., audio input 24 and audio output 26, of device 10.

An application may request the audio focus resource in at least three different ways. (See, e.g., requestAudioFocus( ) function in the example API below.) First, the application may simply request the audio focus resource from resource management module 34 with no further indication of how the application intends on using the audio focus resource. Second, the application may request the audio focus resource from resource management module 34 and indicate that the application will only need the audio focus resource for a short period of time. A limited duration request may be referred to as a transient request. Third, the application may request the audio focus resource from resource management module 34 as a transient request and indicate that it is okay for any application which may currently have the audio focus resource to simply lower the volume or “duck” its audio output.

In one example, no audio is being played or recorded in by any of applications 32 executing within device 10 when one of applications 32, e.g., a music player such as Google Music, requests the audio focus resource from resource management module 34. In this example, resource management module 34 may add the audio resource request received from the music player to the audio resource request stack stored within resource requests 38 and may then grant the music player the ability to output audio via audio output 26.

Continuing the example, a different one of applications 32, e.g., a global positioning system (GPS) or mapping application such as Google Maps, requests the audio focus resource in order to output driving directions by issuing a transient audio focus request to resource management module 34 that including an indication that the GPS application allows any other application which may current have control over the audio focus resource to perform audio “ducking” Audio “ducking” is the process of lowering the volume of the currently outputting audio stream. Resource management module 34 receives the request and may add the audio focus resource request to the audio focus resource request stack stored within resource requests 38. Resource management module 34 may then determine that the GPS application is the top-most application in the audio focus resource request stack and grant the GPS application the usage of the audio focus resource which, in turn, provides the GPS application the ability to output audio via audio output 26.

Resource management module 34 may also be configured to notify the music player that the music player has lost access to the audio focus resource (see, e.g., OnAudioFocusChangeListener interface in the example API below). Resource management module 34 may perform this notification either before or after granting the GPS application access to the audio focus resource. The audio focus loss notification includes an indication of the type of audio focus request received by resource management module 34 that caused the music player to lose access to the audio focus resource. The audio focus loss notification may also include additional information about the GPS application that caused the music player to lose access to the audio focus resource. For example, the audio focus loss notification may include information about the type of application that caused the audio focus loss notification to be sent and whether the application that caused the audio focus loss notification to be sent is the operating system or another application executing on the device. In some examples, the audio focus loss notification may include information that identifies the audio event that caused the audio focus loss notification to be sent as a system sound, such as an email notification or a low battery warning.

Upon receiving the audio focus loss notification, the music player may choose how to handle losing the audio focus resource based on how the music player lost audio focus, e.g., based on the type of audio focus request from the GPS application that pushed the music player down the audio focus resource stack. In this example, the music player may choose to pause the audio playback, mute the audio output, or reduce the volume of the audio output because the music player received notification that it lost audio focus by a transient audio request that allows audio ducking. In other examples, such as where the audio focus loss notification includes information that identifies the audio event that caused the audio focus loss notification to be sent as a system sound, the music player may choose to continue outputting the audio without any changes to the audio output.

To aid in determining how respond to the loss of the audio focus resource, the music player may also consider other factors, such as the type of audio stream currently being outputted by the music player. For example, if the music player is playing music, the music player may elect to mute or duck the audio rather than pausing playback. However, if the music player is playing an audio book or a podcast, the music player may elect to pause playback rather than mute or duck the audio to minimize the listener missing any content of the audio book or podcast.

In some examples, resource management module 34 may grant simultaneous access to a resource of device 10 to multiple applications 32, while managing how each of the applications utilizes the resource. In one example, device 10 is connected to an automobile stereo system and the Google Maps application and the music player application are executing on device 10. In this example, the music player application is granted access to the audio focus resource by resource management module 34 and the music player application outputs audio via audio output 26. While the music player application is outputting audio, the GPS application requests the right to utilize audio output 26 by issuing an audio focus resource request message. The audio focus resource request message may include information about the requesting application, such as the type of application that is issuing the request or the purpose for which the request is being issued.

In this example, the audio focus resource request message includes information that identifies the GPS application as providing driving directions. Resource management module 34 may examine the audio focus resource request message received from the GPS application and determine that, because the GPS application is providing driving directions, the music player application may continue to utilize the audio focus resource. Resource management module 34 may further determine that the audio outputted via audio output 26 needs to be rebalanced such that the driving directions are outputted primarily on the left audio channel (e.g., outputted via the speakers that are closest to the driver) while the music is outputted primarily on the right audio channel.

Resource management module 34 may manage audio input or output being performed by two or more of applications 32 in different ways based on information included within the audio focus resource requests, such as whether the applications requesting use of the resource are performing audio input or audio output, the type of application requesting use of the resource, and the type of audio being outputted (e.g., music, voice, telephone, system notification or alerts, and ringtones).

After the GPS application finishes outputting the audio driving directions (e.g., using audio output 26 of device 10), the GPS application may issue an audio focus resource abandon notification to resource management module 34 (see, e.g., abandonAudioFocus( ) function in the example API below). Resource management module 34 may then remove the corresponding audio focus resource request from the stack, identify the next application corresponding to the audio focus request on the top of the stack, and notify the application that it has regain access to the audio focus resource. In this example, the audio focus request on the top of the stack after removing the audio focus request issued by the GPS application is the audio focus request issued by the music player. Therefore, resource management module 34 may notify the music player that the music player has regained access to the audio focus resource (see, e.g., OnAudioFocusChangeListerner interface in the example API below). The music player may resume or restore the audio playback to the same level as before the GPS application requested the audio focus resource. In this manner, an audio focus resource may be requested and released by various applications executing in a system without each application being aware of other applications operating within the system.

In other examples, another application, executing within the computing device while the music player has access to the audio focus resource, may issue a transient audio focus resource request that does not allow audio ducking or an audio focus resource request of unknown duration (e.g., non-transient). In this example, the music player may either pause/stop audio playback or mute audio playback, but may not reduce its audio output level.

In another embodiment, resource management module 34 may automatically control the audio streams without requiring an application to respond to audio focus gain/loss events. That is, resource management module 34 may pause, stop, or start audio streams as well as control the output volume of the audio streams automatically as access to the audio focus resource is transferred from one application to another. In determining how to manage the audio streams, resource management module 34 may consider user actions, such as starting a game application or a music player application, as well as non-user generated events, such as an email notification or a low battery warning.

In this embodiment, resource management module 34 may manage the audio streams based on a configured default behavior or based on a set of preferences received from one of applications 32 that performs audio input or audio output. For example, the music player and a podcast application, e.g., Google Listen, may provide resource management module 34 with different instructions for managing the respective audio streams. The music player may issue a message to resource management module 34 instructing resource management module 34 to lower the audio output level when the music player loses access to the audio focus resource for a limited duration. Whereas the podcast application may issue a message to resource management module 34 instructing resource management module 34 to pause playback when the podcast application loses access to the audio focus resource for a limited duration.

While described above with respect to a music player and a GPS application, the techniques of this disclosure may also be applied to any of applications 32 executing on the computing device and capable of utilizing audio input 24 or audio output 26. For example, the techniques of this disclosure may be applied to a voice recorder application that may request the audio focus resource for both audio input (e.g., performing voice recording) and audio output (e.g., playing back the recorded voice) and an operating system that may request the audio resource for performing system notifications or alerts.

The techniques of this disclosure may also be applied when one or more of applications 32 utilize transport control device 42 to receive input from a user or provide feedback (e.g., display text or graphics on a display of transport control device 42). For example, application 32N may issue a transport control focus request message to register application 32N with resource management module 34. Resource management module 34 may add the transport control focus request to a first-in-last-out stack that maintains a sequence of registered applications within resource requests 38. Upon successful registration, all events generated via the transport control device 42 may be received by application 32N.

When more than one of applications 32 are registered to receive the events generated via transport control device 42, resource management module 34 directs the events to the application having the highest priority, e.g., the application that is located at the top of the stack. Each application may unregister itself at any time by issuing an unregistration request message to resource management module 34. The application management system unregisters the application by removing it from the stack. After unregistering itself, the application no longer receives events generated via the transport control device. In this manner, a transport control resource may be requested and released by various applications executing in a system without each application being aware of other applications operating within the system.

In one example, a music player may issue a registration request message to receive events generated via transport control device 42 coupled to device 10 to control music playback (see, e.g, registerMediaButtonEventReceiver( ) function in the example API below). Transport control device 42 may include buttons that, when pressed, cause control unit 18 to generate events that are interpreted by the music player application as corresponding to music playback commands, such as play, pause, rewind, fast forward, and skip. In this example, resource management module 34 receives the registration request from the music player and adds the request to the transport control resource request stack. When user 16 presses a button on transport control device 42, the music player receives the events and adjusts playback accordingly. The music player may unregister itself at any time by issuing an unregistration request to resource management module 34 (see, e.g, unregisterMediaButtonEventReceiver( ) function in the example API below). Once unregistered, the music player will no longer receive events generated via transport control device 42. Instead, resource management module 42 may direct the events generated via transport control device 42 to the top application in the stack, if any, after the music player is removed.

In another embodiment, resource management module 34 may automatically manage the transport control focus resource. In one example, when an application capable of receiving transport control events is installed on device 10, such as application 32A, the application notifies resource management module 34 that the application may receive these events by, for example, registering itself in a transport control resource database stored within resource requests 38. Resource management module 34 may then redirect events generated via transport control device 42 to the most recently launched application that is capable of receiving the events based on the information stored in the transport control database and based on the known operating status of device 10.

Example Audio Focus Application Programming Interface (API):

| /** | |
|---|---|
| * | Request audio focus. |
| * | Send a request from the application to the application |

management system to obtain the

| | |
|---|---|
| * | audio focus |
| * | @param l the listener to be notified of audio focus |

changes

| | |
|---|---|
| * | @param streamType the main audio stream type affected by |

the focus request

| | |
|---|---|
| * | @param durationHint use {@link |

#AUDIOFOCUS_GAIN_TRANSIENT} to indicate

| | |
|---|---|
| * | this focus request is temporary, and focus will be |

abandoned shortly, e.g., a transient

| | |
|---|---|
| * | audio focus request. Examples of transient requests |

are for the playback of driving

| | |
|---|---|
| * | directions, or notifications sounds. |
| * | Use {@link #AUDIOFOCUS_GAIN_TRANSIENT_MAY_DUCK} to |

indicate also

| | |
|---|---|
| * | that it's ok for the previous focus owner to keep |

playing if it ducks its audio output.

| | |
|---|---|
| * | Use {@link #AUDIOFOCUS_GAIN} for a focus request of |

unknown duration such

| | |
|---|---|
| * | as the playback of a song or a video. |

| | |
|---|---|
| * | @return {@link #AUDIOFOCUS_REQUEST_FAILED} or |

| | |
|---|---|
| * | {@link #AUDIOFOCUS_REQUEST_GRANTED} |

*/
public int requestAudioFocus (OnAudioFocusChangeListener l,

int streamType, int durationHint) {

/* Invoke OnAudioFocusChangeListener for previous focus

owner to indicate change in status. Add new request to stack of
prioritized requests */

| } | |
|---|---|
| /** | |
| * | Abandon audio focus. The abandon audio focus request |

causes the previous focus owner, if

| | |
|---|---|
| * | any, to receive focus. |
| * | @param l the listener with which focus was requested. |
| * | @return {@link #AUDIOFOCUS_REQUEST_FAILED} or |

| | |
|---|---|
| * | {@link #AUDIOFOCUS_REQUEST_GRANTED} |

*/
public int abandonAudioFocus (OnAudioFocusChangeListener l) {

/* Remove top-most request from stack. Invoke

OnAudioFocusChangeListener for application associated with top-
most request on stack (prior focus owner) to indicate change in
status.*/

}
/**
* Indicates a failed focus change request.
*/
public static final int AUDIOFOCUS_REQUEST_FAILED = 0;
/**
* Indicates a successful focus change request.
*/
public static final int AUDIOFOCUS_REQUEST_GRANTED = 1;
/**
* AUDIOFOCUS_GAIN is used to indicate a gain of audio focus,

or a request of audio focus,

* of unknown duration.
* @see OnAudioFocusChangeListener#onAudioFocusChange(int)
* @see #requestAudioFocus(OnAudioFocusChangeListener, int,

int)

*/
public static final int AUDIOFOCUS_GAIN = 1;
/**
* AUDIOFOCUS_GAIN_TRANSIENT is used to indicate a temporary

gain or request of

* audio focus, anticipated to last a short amount of time.

Examples of temporary changes are

* the playback of driving directions, or an event

notification.

* @see OnAudioFocusChangeListener#onAudioFocusChange(int)
* @see #requestAudioFocus(OnAudioFocusChangeListener, int,

int)

*/
public static final int AUDIOFOCUS_GAIN_TRANSIENT = 2;
/**
* AUDIOFOCUS_GAIN_TRANSIENT_MAY_DUCK is used to indicate a

temporary

* request of audio focus, anticipated to last a short amount

of time, and where it is acceptable

* for other audio applications to keep playing after having

lowered their output level (also

* referred to as “ducking”).
* Examples of temporary changes are the playback of driving

directions where playback of

* music in the background is acceptable.
* @see OnAudioFocusChangeListener#onAudioFocusChange(int)
* @see #requestAudioFocus(OnAudioFocusChangeListener, int,

int)

*/
public static final int AUDIOFOCUS_GAIN_TRANSIENT_MAY_DUCK =

3;

/**
* AUDIOFOCUS_LOSS is used to indicate a loss of audio focus

of unknown duration.

* @see OnAudioFocusChangeListener#onAudioFocusChange(int)
*/
public static final int AUDIOFOCUS_LOSS = −1 *

AUDIOFOCUS_GAIN;

/**
* AUDIOFOCUS_LOSS_TRANSIENT is used to indicate a transient

loss of audio focus.

* @see OnAudioFocusChangeListener#onAudioFocusChange(int)
*/
public static final int AUDIOFOCUS_LOSS_TRANSIENT = −1 *

AUDIOFOCUS_GAIN_TRANSIENT;

/**
* AUDIOFOCUS_LOSS_TRANSIENT_CAN_DUCK is used to indicate a

transient loss of

* audio focus where the loser of the audio focus can lower

its output volume if it wants to

* continue playing (also referred to as “ducking”), as the

new focus owner doesn't require

* others to be silent.
* @see OnAudioFocusChangeListener#onAudioFocusChange(int)
*/
public static final int AUDIOFOCUS_LOSS_TRANSIENT_CAN_DUCK =

−1 * AUDIOFOCUS_GAIN_TRANSIENT_MAY_DUCK;

/**
* Interface definition for a callback to be invoked when the

audio focus of the system is

* updated.
*/
public interface OnAudioFocusChangeListener {

/**
* onAudioFocusChange( ) is called on the listener to

notify it the audio focus for this

* listener has been changed.
* The focusChange value indicates whether the focus was

gained,

* whether the focus was lost, and whether that loss is

transient, or whether the new focus

* holder will hold it for an unknown amount of time.
* When losing focus, listeners can use the focus change

information to decide what

* behavior to adopt when losing focus. A music player

could for instance elect to lower

* the volume of its music stream (duck) for transient

focus losses, and pause otherwise.

| * @param focusChange the type of focus change, one of | |
|---|---|
| * | {@link AudioManager#AUDIOFOCUS_GAIN}, |
| * | {@link AudioManager#AUDIOFOCUS_LOSS}, |
| * | {@link AudioManager#AUDIOFOCUS_LOSS_TRANSIENT} |
| * | and {@link |

AudioManager#AUDIOFOCUS_LOSS_TRANSIENT_CAN_DUCK}.

*/
public void onAudioFocusChange(int focusChange);

}

Example Headset/Remote control API:

/**
* Register a component to be the sole receiver of

MEDIA_BUTTON intents.

* @param eventReceiver identifier of a {@link

android.content.BroadcastReceiver}

| | |
|---|---|
| * | that will receive the media button intent. This |

broadcast receiver must be declared

| | |
|---|---|
| * | in the application manifest. |

*/
public void registerMediaButtonEventReceiver (ComponentName

eventReceiver) { }

/**
* Unregister the receiver of MEDIA_BUTTON intents.
* @param eventReceiver identifier of a {@link

android.content.BroadcastReceiver}

| | |
|---|---|
| * | that was registered with |
| * | {@link |

#registerMediaButtonEventReceiver(ComponentName)}.

*/
public void unregisterMediaButtonEventReceiver(ComponentName

eventReceiver) { }

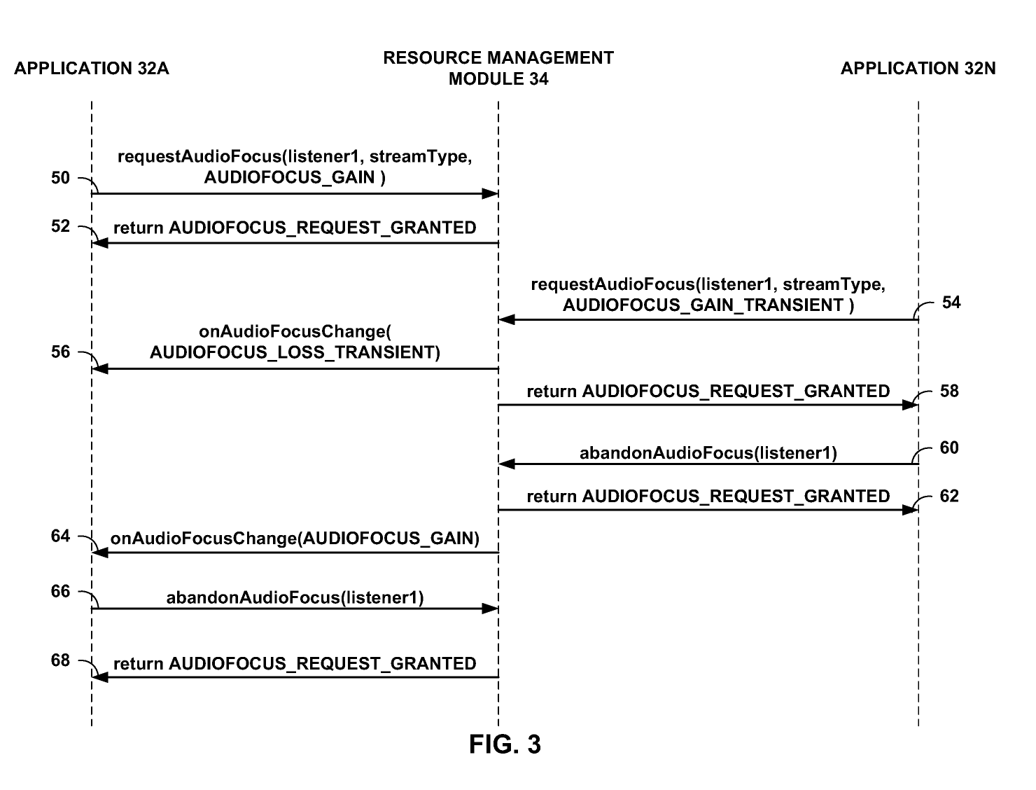

FIG. 3 is a conceptual diagram illustrating an example method for managing and using computing resources, in accordance with one aspect of the present disclosure. For purposes of illustration only, the method of FIG. 3 is described with respect to computing system 2 of FIG. 1 an the example AudioFocus API described above, though various other systems and/or devices may be utilized to implement or perform the method shown in FIG. 3. In the example illustrated in FIG. 3, application 32A issues a requestAudioFocus( ) command with the parameters listener, streamType, and AUDIOFOCUS_GAIN (50). Listener identifies an instance of the OnAudioFocusChangeListener interface that is invoked with the audio focus is updated, streamType indicates the audio stream type affected by the audio focus request, and AUDIOFOCUS_GAIN indicates the type of audio focus request. Resource management module 34 receives the requestAudioFocus( ) command, adds the request to the data repository, determines whether the request will be granted based on the priority of the request, and then returns AUDIOFOCUS_REQUEST_GRANTED in response to determining that application 32A will receive access to the audio focus resource (52).

At a later time, while application 32A is still using the audio resource, application 32N issues a requestAudioFocus( ) command to resource management module 34 (54). Resource management module 34 receives the request, determines that application 32A is currently using the audio focus resource, and then determines which application has the priority to use the audio focus resource. In the example illustrated in FIG. 3, application 32N has priority over application 32A to use the audio focus resource. Therefore, resource management module 34 generates an on AudioFocusChange event based on the parameters included in the requestAudioFocus( ) command that caused the lower priority application to lose access to the audio focus resource. In this example, the requestAudioFocus( ) command includes the parameter AUDIOFOCUS_GAIN_TRANSIENT, which indicates that the audio focus request is a transient request. Resource management module 34 then generates the on AudioFocusChange( ) command with the parameter AUDIO_FOCUS_LOSS_TRANSIENT because the requestAudioFocus( ) command indicated it was a transient request and sends the command to application 32A (56). Because resource management module 34 determined that application 32N is granted access to the audio focus resource, resource management module 34 then returns the AUDIOFOCUS_REQUEST_GRANTED result to application 32N (58).

After application 32N is done using the audio focus resource, application 32N issues an abandonAudioFocus( ) command to resource management module 34 (60). Upon successfully revoking application 32N's access to the audio focus resource, resource management module 34 returns the AUDIOFOCUS_REQUEST_GRANTED result to application 32N (62) and sends the on AudioFocusChange( ) command with the parameter AUDIOFOCUS_GAIN to application 32A, indicating that application 32A has regained full access to the audio focus resource (64). When application 32A no longer requires access to the audio focus resource, application 32A issues an abandonAudioFocus( ) command to resource management module 34 (66). Resource management moduler 34 then removes the audio focus resource request associated with application 32A from the data repository and returns an AUDIOFOCUS_REQUEST_GRANTED result to indicate that the audio focus request associated with application 32A was successfully removed from the data repository (68). In this manner, resource management module 34 may manage multiple requests for the same resource from multiple applications 32 executing on device 10.

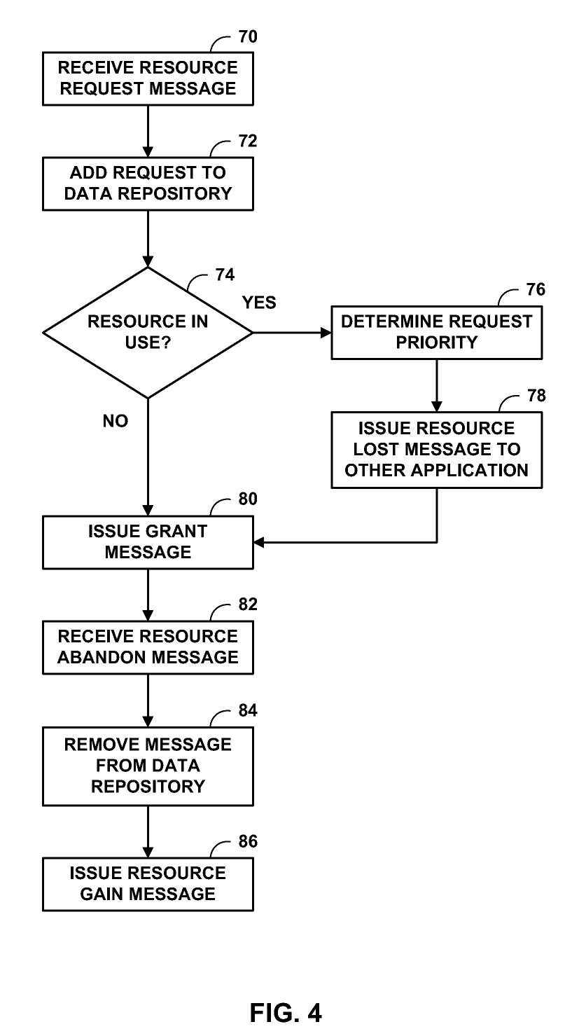

FIG. 4 is a flowchart illustrating an example method for managing computing resources, in accordance with one aspect of the present disclosure. For purposes of illustration only, the method of FIG. 4 is described with respect to computing system 2 of FIG. 1, though various other systems and/or devices may be utilized to implement or perform the method shown in FIG. 4. Resource management module 34 receives a resource focus request from one of applications 32 (70) and adds the request to a data repository configured to store resource requests (72). A different data repository may be configured to store each type of resource focus request or a single data repository may be configured to store all of the resource focus requests. In the examples where a single data repository stores all of the resource focus requests, resource management module 34 maintains a separate priority for each resource as if a data repository were configured for each resource. For example, if application 32A issues an audio focus resource request and application 32N issues a transport control focus resource request, resource management module 34 grants application 32A access to the audio focus resource while granting application 32N simultaneous access to the transport control focus resource even though both resource requests may be stored within a single data repository.

After adding the resource request to the data repository (72), resource management module 34 determines whether the requested resource in already in use by another application (74). Resource management module 34 may determine that the request resource is already in use by, for example, determining that more than one resource request for the same resource exists within resource requests 38. If the requested resource is already in use (“YES” branch of 74), resource management module 34 determines which application has the priority to use the requested resource (76). In one example, the application which was most recently added to the data repository (e.g., the application that most recently requested the resource focus resource) is the highest priority application. In another example, a limited duration, or transient, resource focus request is determined to have a higher priority than a resource focus request having an indeterminate duration.

For the applications that are not determined to be the highest priority application, resource management module 34 may issue a resource lost message to notify the lower priority applications that they do not have access to the resource (78). The resource lost message corresponds to the type of resource request message received from the application having the highest priority. For example, if the resource request message indicates it is a transient request, the resource lost message will indicate that the loss of the resource may be for a limited duration. Resource management module 34 then issues a resource grant message to the highest priority application to notify the highest priority application than it has been granted access to the requested resource (80). If resource management module 34 determines that the requested resource is not already in use by another application (“NO” branch of 74), resource management module 34 issues a resource grant message to the highest priority application to notify the highest priority application than it has been granted access to the requested resource (80).

After the highest priority application is done using the requested resource, resource management module 34 receives an abandon resource message from the application that was using the resource (82). In response to receiving the abandon message, resource management module 34 removes the corresponding resource request from the data repository (84). If there are any resource requests remaining in the data repository, resource management module 34 issues a resource gain message to the application associated with the resource focus request having the highest priority to grant the highest priority application access to the requested resource focus resource (86).

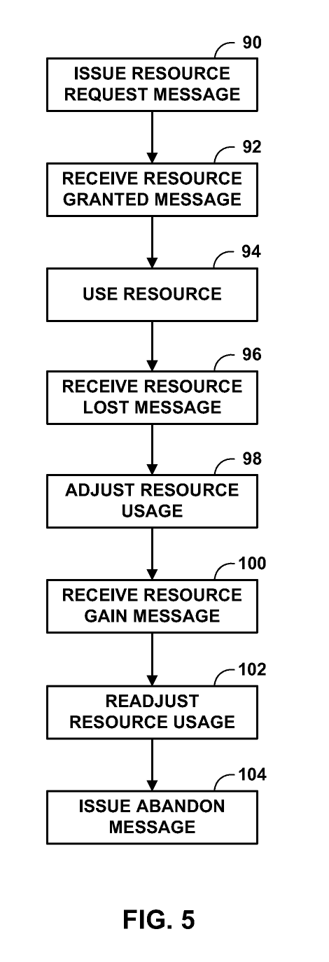

FIG. 5 is a flowchart illustrating an example method for using computing resources, in accordance with one aspect of the present disclosure. For purposes of illustration only, the method of FIG. 5 is described with respect to computing system 2 of FIG. 1, though various other systems and/or devices may be utilized to implement or perform the method shown in FIG. 4. In the example method of FIG. 4, an application executing within device 10, e.g., application 32A, requests the usage of a resource of device 10, e.g., audio input 24 and/or audio output 26, by requesting the resource focus resource, e.g., the audio focus resource that resource management module 34 manages to control usage of audio input 24 and audio output 26 (90). The resource focus request message may include one of at least three different types of resource focus requests messages.

In one example, application 32A requests the resource focus resource with no additional information. In another example, application 32A requests the resource focus resource for a limited duration. In yet another example, application 32A requests the resource focus resource associated with audio input 24 and audio output 26, e.g., the audio focus resource. In this example, the audio focus request indicates that the audio focus request is for a limited duration and that any other application that may have the audio focus prior to application 32A gaining the audio focus, is allowed to reduce, or “duck” its volume level if the application losing the audio focus is so configured.

After requesting the resource focus resource from resource management module 34, application 32A may be configured to wait until after application 32A receives a resource granted message from resource management module 34 before trying to use the requested resource (92). In some example, the most recent requesting application may not be the highest priority application and may therefore have to wait until the higher priority application stops using the requested resource. If application 32A attempts to use the request resource prior to receiving the resource granted message, such attempts may fail. After receiving the resource granted message (92), application 32A uses the requested resource (94).

If another application executing on device 10, e.g., application 32N, requests the same resource while application 32A is using the resource, application 32A may receive a resource lost message from resource management module 34 (96). The resource lost message may generated by resource management module 34 based on the resource request message that caused application 32A to lose access to the requested resource. That is, the resource lost message may indicate the type of resource request message that caused application 32A to lose access to the requested resource. For example, resource management module 34 may generate a resource lost message that indicates that the resource was lost with no further information based on a resource request that includes no further information. In another example, resource management module 34 may generate a resource lost message that indicates the resource is lost for a limited duration in response to receiving a transient resource request. In another example, resource management module 34 may generate a resource lost message that indicates the resource is lost for a limited duration and that audio “ducking” by application 32A is permitted.

After receiving the resource lost message (96), application 32A may adjust its usage of the resource (98). In one example, application 32A receives a resource lost message for the audio focus resource that indicates the audio focus is lost for a limited duration and that audio “ducking” is permitted. In response to this resource lost message, application 32A may stop audio playback or recording, mute audio playback, or reduce the audio playback volume, for example. Application 32A may be configured to respond differently based on the way in which application 32A is using the audio focus resource. If, for example, application 32A is recording audio, application 32A may be configured to stop audio recording upon losing access to the audio focus resource. If application 32A is performing audio output by playing back a podcast or an audio book, for example, application 32A may be configured to pause the playback until application 32A regains access to the audio focus. In another example, if application 32A is performing audio output by playing back music, application 32A may be configured to mute the audio output while continuing to playback the music until application 32A regains access to the audio focus.

When the application that caused application 32A to lose access to the resource focus resource stops using the requested resource, resource management module 34 issues a resource gain message to application 32A. Application 32A receives the resource gain message (100) and may adjust the usage of the requested resource in response to receiving the resource gain message (102). In some examples, application 32A resumes using the requested resource in the same manner in which application 32A was using the requested resource prior to losing access to the requested resource. In other examples, application 32A may complete usage of the requested resource while the other application is using the resource and may issue a resource abandon message to resource management module 34 and therefore may not resume usage of the requested resource. When application 32A finished using the requested resource, application 32A may be configured to issue a resource abandon message to resource management module 34 to notify resource management module 34 that the requested resource is available to be used by other applications (104).

In this manner, an application may utilize a computing resource of a computing device without information about other applications executing on the computing device and without information about any other applications that may already be using the desired computing resource. Furthermore, the techniques of this disclosure may enable an application to better control what happens when another application attempts to use a computing resource currently being used by the application. Thus, the techniques of this disclosure may provide better management of the usability issues that arise when an application attempts to use a computing resource of a computing device when another application is already using the computing resource. By better managing usability issues arising from computing resource conflicts, the user experience for an end user of the computing device may be improved.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as RAM, ROM, NVRAM, EEPROM, FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code or instructions may be software and/or firmware executed by processing circuitry including one or more processors, such as one or more digital signal processors (DSPs), general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

Various embodiments of the disclosure have been described. These and other embodiments are within the scope of the following claims.

1. An article of manufacture comprising a computer-readable medium encoded with instructions for causing one or more programmable processors of a computing device to:
receive, from a first application, a resource request message to obtain access to a computing resource of the computing device;
store the resource request message in a data repository, wherein the data repository stores a collection of resource request messages received from a group of applications executing on the computing device;
responsive to determining that the resource request message received from the first application has a highest priority of the collection of resource request messages, determine whether a second application currently has access to the computing resource;
responsive to determining that the second application currently has access to the computing resource, issue a resource lost message to the second application to indicate that the second application has lost access to the computing resource; and
issue a resource request granted message to the first application indicating that the resource request message has been granted, such that the first application obtains access to the computing resource.

2. The article of manufacture of claim 1 further encoded with instructions for causing the one or more programmable processors to:
responsive to determining that the second application currently has access to the computing resource, issue the resource lost message to the second application, wherein the resource lost message is based on the resource request received from the first application;
receive a resource abandon message from the first application; and
responsive to receiving the resource abandon message, issue a resource gain message to the second application indicating that the second application has regained access to the computing resource.

3. The article of manufacture of claim 2 further encoded with instructions for causing the one or more programmable processors to determine if one or more resource request messages are included in the data structure prior to adding the resource request message received from the first application in order to determine if a second application previously requested access to the computing resource.

4. The article of manufacture of claim 1, wherein the computing resource is an audio focus resource or a transport control resource, wherein the audio focus resource corresponds to at least one of an audio output or an audio input of a computing device, and wherein the transport control resource is at least one of a remote control coupled to the computing device, a headphone having physical buttons coupled to the computing device, or physical or virtual buttons located on the computing device.

5. An article of manufacture comprising a computer-readable medium encoded with instructions for causing one or more programmable processors to:
issue a resource request message to a resource management module, wherein the resource request message requests access to a computing resource managed by the resource management module;
receive a resource request granted message from the resource management module indicating that the resource request message has been granted;
responsive to receiving the resource requested granted message, utilize the computing resource;
receive a resource lost message from the resource management module indicating that access to the computing resource is lost; and
upon completing usage of the computing resource, issue a resource abandon message to the resource management module indicating a release of access to the computing resource.

6. The article of manufacture of claim 5,
wherein the resource request message comprises one of an audio focus resource request message or a transport control registration request message, and
wherein the audio focus resource request message comprises at least one of an audio focus request for an unknown duration message, an audio focus request for a limited duration message, and an audio level reduction permitted request for a limited duration message.

7. The article of manufacture of claim 5, wherein the resource request message comprises an audio focus resource request to obtain access to the computing resource for purposes of audio playback or audio recording by the first application, and wherein the article of manufacture is further encoded with instructions for causing the one or more programmable processors to:
in response to receiving the resource lost message, determine whether to pause the audio playback or the audio recording, mute the audio playback, or reduce a volume of the audio playback based on the audio focus resource lost message.

8. The article of manufacture of claim 7, further encoded with instructions for causing the one or more programmable processors to:
after receiving the resource lost message, receive a resource gained message from the resource management module indicating that access to the computing resource has been regained by the first application; and
resume performing the audio playback or the audio recording.

9. The article of manufacture of claim 7, wherein the resource lost message comprises one of an audio focus lost for an unknown duration message, an audio focus lost for a limited duration message, or an audio level reduction permitted lost for a limited duration message.

10. A method comprising:
receiving, from a first application with a resource management module executing on a computing device, a resource request message to obtain access to a computing resource;
storing the resource request message in a data repository with the resource management module, wherein the data repository stores a collection of resource request messages received from a group of applications executing on the computing device;
responsive to determining that the resource request message received from the first application has a highest priority of the collection of resource request messages, determining whether a second application currently has access to the computing resource;
responsive to determining that the second application currently has access to the computing resource, issuing, with the resource management module, a resource lost message to the second application to indicate that the second application has lost access to the computing resource; and
issuing, with the resource management module, a resource request granted message to the first application indicating that the resource request message has been granted, such that the first application obtains access to the computing resource.

11. The method of claim 10, further comprising:
responsive to determining that the second application currently has access to the computing resource, issuing the resource lost message to the second application, wherein the resource lost message is based on the resource request received from the first application;
receiving a resource abandon message from the first application; and
responsive to receiving the resource abandon message, issuing a resource gain message to the second application indicating that the second application has regained access to the computing resource.

12. The method of claim 10, further comprising determining if one or more resource request messages are included in the data structure prior to adding the resource request message received from the first application in order to determine if a second application previously requested access to the computing resource.

13. The method of claim 10, wherein the computing resource is an audio focus resource or a transport control resource, wherein the audio focus resource corresponds to at least one of an audio output or an audio input of a computing device, and wherein the transport control resource is at least one of a remote control coupled to the computing device, a headphone having physical buttons coupled to the computing device, or physical or virtual buttons located on the computing device.

14. A method comprising:
issuing, with an application executing on a computer, a resource request message to a resource management module, wherein the resource request message requests access to a computing resource managed by the resource management module;
receiving, with the application, a resource request granted message from the resource management module indicating that the resource request message has been granted;
in response to receiving the resource requested granted message, using the computing resource with the application;
receiving a resource lost message from the resource management module indicating that access to the computing resource is lost; and
upon completing usage of the computing resource, issuing, with the application, a resource abandon message to the resource management module indicating a release of access to the computing resource.

15. The method of claim 14,
wherein the resource request message comprises one of an audio focus resource request message or a transport control registration request message, and
wherein the audio focus resource request message comprises at least one of an audio focus request for an unknown duration message, an audio focus request for a limited duration message, and an audio level reduction permitted request for a limited duration message.

16. The method of claim 14, wherein the resource request message comprises an audio focus resource request to obtain access to the computing resource for purposes of audio playback or audio recording by the first application, and wherein the method further comprises:
in response to receiving the resource lost message, determining whether to pause the audio playback or the audio recording, mute the audio playback, or reduce a volume of the audio playback based on the audio focus resource lost message.

17. The method of claim 16, further comprising:
after receiving the resource lost message, receiving a resource gained message from the resource management module indicating that access to the computing resource has been regained by the first application; and
resume performing the audio playback or the audio recording.

18. The method of claim 16, wherein the resource lost message comprises one of an audio focus lost for an unknown duration message, an audio focus lost for a limited duration message, or an audio level reduction permitted lost for a limited duration message.

19. A system comprising:
one or more processors;
a first application executable by the one or more processors;
a computing resource;
a data repository configured to store a sequence of resource request messages received from a group of applications executing on the one or more processors;
a resource management module executable by the one or more processors to receive, from the first application, a resource request message to obtain access to a computing resource from a first application, store the resource request message in the data repository, responsive to determining that the resource request message received from the first application has a highest priority of the collection of resource request messages, determine whether a second application currently has access to the computing resource, and, responsive to determining that the second application currently has access to the computing resource, issue a resource lost message to the second application to indicate that the second application has lost access to the computing resource; and
means for issuing a resource request granted message to the first application indicating that the resource request message has been granted, such that the first application obtains access to the computing resource.

20. A computer system comprising:
one or more processors;
a set of computing resources;
means for managing the set of computing resources; and
a software application executable by the one or more processors to issue a resource request message to the resource management module, wherein the resource request message requests access to a computing resource managed by the means for managing the set of computing resources, receive a resource request granted message from the means for managing the set of computing resources indicating that the resource request message has been granted, utilize the computing resource in response to receiving the resource requested granted message, receive a resource lost message from the for managing the set of computing resources indicating that access to the computing resource is lost, and, upon completing usage of the computing resource, issue a resource abandon message to the means for managing the set of computing resources to indicate a release of access to the computing resource.
